(19) United States
(12) Patent Application Publication
(10) Pub. No.: US 2005/0177846 A1
(43) Pub. Date: Aug. 11, 2005

(54) Contents extraction method, contents extraction apparatus, contents information display method and apparatus

(75) Inventors: Kazuna Maruyama, Tokyo (JP); Yasushi Shikata, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/991,399

(22) Filed: Nov. 19, 2004

(30) Foreign Application Priority Data
Nov. 21, 2003 (JP) 2003-392151

(51) Int. Cl. H04N 7/16; G06F 13/00; H04N 7/10; H04N 7/025; H04H 9/00

(52) U.S. Cl. 725/35; 348/563; 348/473; 725/9; 725/46; 725/34

(57) ABSTRACT

A set age of a user is updated on the basis of information of the birth date of the user and date information updated with time. Taste information of the user is learned on the basis of operation history information of the user and contents related information corresponding to the operation. Contents extraction conditions are reset in accordance with the taste information of the user and the updated set age, and contents which can be an object to be watched by the user are extracted from a plurality of contents depending on the reset extraction conditions.

### BACKGROUND OF THE INVENTION

1. Field of the Invention

The present invention relates to a method and apparatus which extract specific contents from a plurality of contents and a method and apparatus which display information related to extracted contents.

2. Description of the Related Art

In current analog and digital broadcasting or terrestrial digital broadcasting which will be started on the end of 2003, programs and program related information (metadata) are transmitted.

The metadata is data including broadcasting dates, channel information, titles and categories of programs.

The metadata to be handled in server-type broadcasting the standardization of which is currently in progress can handle information which is more detailed than information handled by metadata in current BS digital broadcasting or the like. The metadata in the server-type broadcasting includes, in addition to information of titles, categories, and the like, various information such as credit information such as cast or staffs of programs, warning information representing levels of delineations of violence and sex, target user information representing an audience group intended by a program oriented to infants, business managers, or the like.

The metadata is transmitted prior to actual broadcasting. An electronic program guide (EPG) is known as a typical function using the metadata which is received in advance. The electronic program guide is a function that displays channels, broadcasting time, and program titles serving as the metadata on a screen. In this function, categories are displayed by different colors or different marks, detailed information such as a descriptive text or cast is displayed, parental lock information such as a parental guide is displayed, so that watching of a user is supported. Television sets, tuners, and recorders on which electronic program guides are installed and an internet electronic program guide have been popularized.

As a function using the metadata, a program recommending function is also known. As recommending functions using program related information, a filter recommending function that recommends a program matched with user taste information including a favorite program category, a favorite pop star name or the like which are registered by a user, a learning recommending function that extracts user taste information from metadata of a programs watched or recorded in past or operation history information and recommends a program on the basis of the user taste information, a hybrid recommending function obtained by mixing the filter recommending function and the learning recommending function, and the like are known.

Some user support function such as an electronic program or program recommendation is associated with the following user's designation or user's taste. That is, a pay program is not displayed on an electronic program guide or recommended for the electronic program guide, a program for only 18 and older is not displayed on the electronic program guide or recommended for the electronic program guide, and only baseball and football programs of sports programs are clearly displayed on the electronic program guide or recommended for the electronic program guide.

As patent documents related to a technique that perform user support, Japanese Unexamined Patent Publication No. 10-243309 and Japanese Unexamined Patent Publication No. 2002-271711 are cited.

### SUMMARY OF THE INVENTION

However, in many cases, the association with user's designation or user's taste is performed only once when a device having such a function is purchased. The association tends not to be changed.

In such a case, even in a change in taste and age of the user, the corresponding programs are not displayed on the electronic program guide or recommended for the electronic program guide, so that the user misses programs that suit the taste of the user. As a result, user support is not performed, and the setting may be rather an impediment to television watching. The setting must be changed to avoid such a situation. However, in order to change the setting, the user must display a screen for change or the like and change the setting by herself/himself.

When the setting is changed by a user, for example, when set values of age limit for watching are changed from 17 to 18, or when the user starts to watch a program coping with English voice from the beginning of this fiscal year, the number of programs which can be displayed on the electronic program guide and the number of programs to be recommended excessively increase. For this reason, the accuracy and visibility of the electronic program guide to be provided may be deteriorated.

An object of the present invention is to support extraction of contents suitable for the age and taste of a user without causing the user to consciously change the setting and taste of the user.

In order to achieve the above object, the following configurations are employed. More specifically, there is provided a contents extraction method including the step of:
updating a set age of a user on the basis of information related to reference time at which the set age of the user is updated and time information which is updated with time;
resetting extraction conditions of contents such that at least one of the contents extracted before the updating is excluded in accordance with taste information of the user and the updated set age; and
extracting contents which can be an object to be watched by the user from a plurality of contents depending on the extraction conditions.

The present invention provides a contents extraction method including the step of:
updating a set age of a user on the basis of information related to reference time at which the set age of the user is updated and time information which is updated with time;
resetting extraction conditions of contents in accordance with taste information of the user and the updated set age; and
extracting contents which can be an object to be watched by the user from a plurality of contents depending on the extraction conditions.

The present invention provides a contents information display method which can update a display state of information related to the contents extracted by the contents extraction method in accordance with updating of a set age.

The present invention provides a contents extraction apparatus including:
an age-increase process unit which updates a set age of a user on the basis of information related to reference time at which the set age of the user is updated and time information which is updated with time;
a contents related information holding unit which holds contents related information associated with the contents;
a user taste information learning unit which learns taste information of the user on the basis of operation history information of the user and contents related information corresponding to the operation;
a condition resetting unit which resets extraction conditions of contents such that at least one of the contents extracted before the updating is excluded in accordance with taste information of the user and the updated set age; and
a contents extraction unit which extracts contents which can be an object to be watched by the user from a plurality of contents depending on the reset extraction conditions.

The present invention provides a contents extraction apparatus including:
an age-increase process unit which updates a set age of a user on the basis of information related to reference time at which the set age of the user is updated and time information which is updated with time;
a contents related information holding unit which holds contents related information associated with the contents;
a user taste information learning unit which learns taste information of the user on the basis of operation history information of the user and contents related information corresponding to the operation;
a condition resetting unit which resets extraction conditions of contents in accordance with taste information of the user and the updated set age; and
a contents extraction unit which extracts contents which can be an object to be watched by the user from a plurality of contents depending on the reset extraction conditions.

The present invention provides a display apparatus including:
the contents extraction apparatus;
a display unit which displays information related to the contents; and
a display method change unit which updates a display state of information related to the extracted contents depending on updating of a set age.

According to the present invention, contents extraction conditions in which user taste information based on histories such as watching and recording histories of programs is reflected are reset in an increase in age without being operated by a user, so that the contents extraction conditions can be automatically updated. In this manner, the user can extract contents suitable for the taste and age of the user without resetting the contents extraction conditions.

### BRIEF DESCRIPTION OF THE DRAWINGS

FIG. 1 is a functional block diagram of a contents extraction method according to a first embodiment;

FIG. 2 shows an example of contents extraction conditions in the first embodiment;

FIGS. 3A and 3B are processing flow charts of an age-increase process unit 5 in the first embodiment;

FIG. 4 shows a display of general-purpose conditions in the first embodiment;

FIG. 5 is a classification table related to set value determination in the first embodiment;

FIG. 6 is a processing flow chart of a condition resetting process unit 6 in the first embodiment;

FIGS. 7A and 7B show displays of extraction target contents in the first embodiment;

FIG. 8 is a conceptual diagram of extraction target contents transition in the first embodiment;

FIG. 9 is a functional block diagram of a contents extraction method according to a second embodiment;

FIG. 10 is a processing flow chart of a narrow-down processing unit 8 in the second embodiment;

FIG. 11 is a conceptual diagram of a narrow-down process for extraction target contents in the second embodiment;

FIG. 12 is a functional block diagram of a contents extraction method according to a third embodiment;

FIG. 13 shows a display of a contents list in the third embodiment;

FIG. 14 is a processing flow chart of a display method change processing unit 9 in the third embodiment;

FIG. 15 is a processing flow chart of the display method change processing unit 9 in the third embodiment;

FIGS. 16A and 16B show displays of contents lists in the third embodiment;

FIGS. 17A and 17B show displays of contents lists in the third embodiment.

### DETAILED DESCRIPTION OF THE PREFERRED EMBODIMENTS

Embodiments of the present invention will be described below with reference to the accompanying drawings.

### First Embodiment

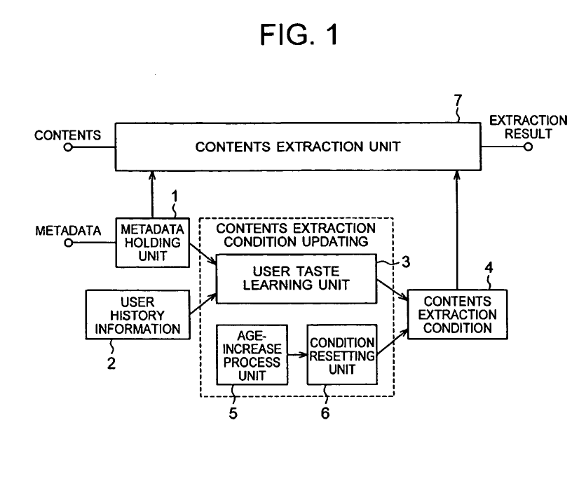

FIG. 1 is a functional block diagram of a contents extraction method to which the first embodiment of the present invention is applied.

A metadata holding unit 1 holds program related information (metadata) transmitted from a broadcast station or the like. A user taste learning unit 3 learns the taste of a user by using the metadata held by the metadata holding unit 1 and the user operation history information 2 to generate contents extraction conditions 4. The taste of the user is extracted by analyzing metadata of programs corresponding to operation history information of the user such as watching and recording history information. Since the contents extraction conditions 4 are based on the taste of the user, different users have different contents extraction conditions 4, respectively. On the other hand, an age-increase process unit 5 updates a set age of the user if necessary on the basis of current date information and the birth date information of the user. When the set age of the user is updated, a condition resetting unit 6 updates the contents extraction conditions 4.

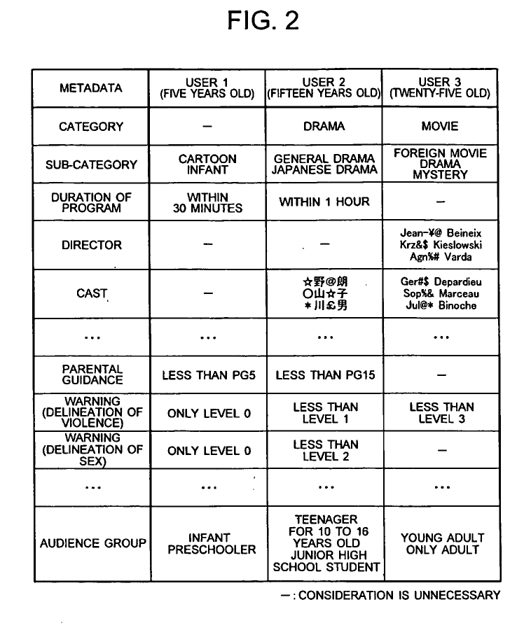

FIG. 2 shows an example of the contents extraction conditions 4. Resetting of conditions in accordance with age-increase process is performed to a part of the metadata shown in FIG. 2. A contents extraction unit 7 specifies contents having metadata which satisfies the contents extraction conditions 4 in the metadata held in the metadata holding unit 1 to acquire corresponding contents from broadcast waves or the like.

The age-increase process unit 5 holds current date information (time information), the age of a user, and an age-increase date and performs age-increase process on the basis of these pieces of information. The age-increase date is a reference date on which a set age of the user is updated. As the age-increase date, the birth date of the user or the start date of a year or a fiscal year such as January first or April first is set in advance.

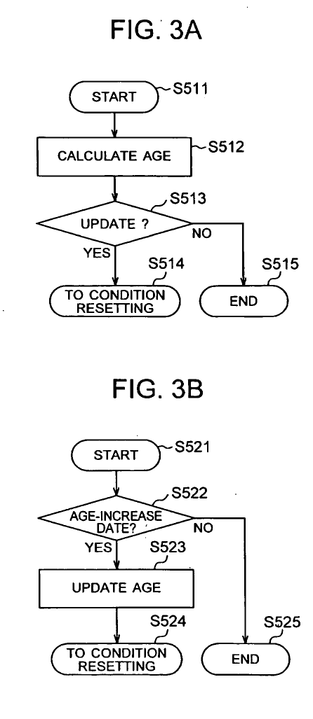

FIGS. 3A and 3B show examples of processing flows of the age-increase process unit 5. An age-increase process is started at power-on time of the apparatus to which the present invention is applied or appointed time (every 3 a.m. or the like) (S511 and S521). In FIG. 3A, the age of a user is calculated from current date information and an age-increase date (S512). When the age of the user is updated (yes in S513), a resetting process is performed (S514). When the age of the user is not updated (no in S513), the age-increase process is ended (S515). In FIG. 3B, when the current date information is the age-increase time, (yes in S522), the age of the user is updated (S523), and the resetting process is performed (S524). When the current date information is not the age-increase date (no in S522), the age-increase process is ended (S525).

The condition resetting unit 6 holds general-purpose conditions depending an age, and resets conditions for contents extraction on the basis of the general-purpose conditions and the taste of the user. The general-purpose conditions depending on an age are conditions for allocating the valid/invalid of metadata and an allowable set value to each age.

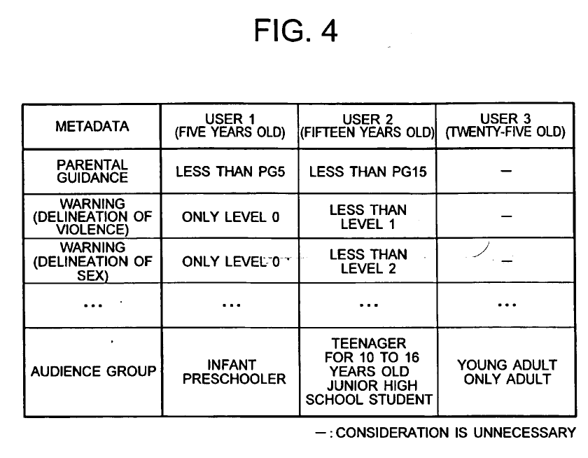

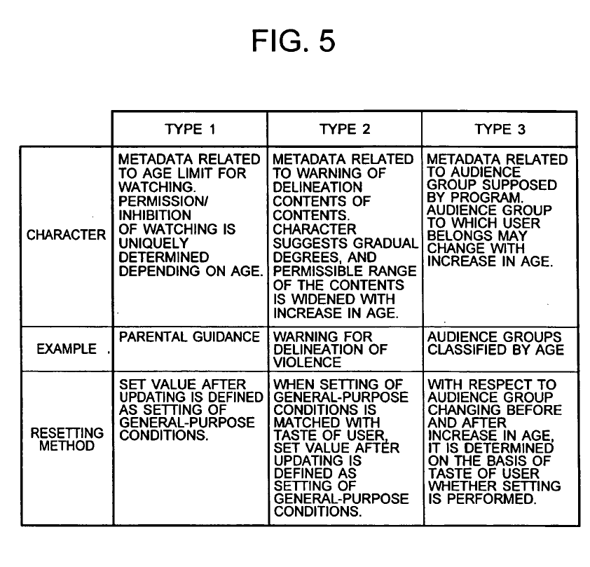

FIG. 4 shows an example of the general-purpose conditions. Metadata handled under the general-purpose conditions is metadata related to an age. The metadata includes metadata related to age limit for watching such as a parental guidance, metadata related to warning of delineations of violence, sex, or the like, or metadata related to an audience group supposed by a program oriented to infant, business managers, or the like. Associations between set values of metadata and ages include associations that are determined by a country or an industry group and must be obeyed (parental guidance or the like) and associations that can be used by discretion on the reception side (television tuner or the like) of metadata (audience group supposed by a program). Set conditions of the metadata related to ages are determined in units of ages to obtain general-purpose conditions corresponding to the ages. An apparatus or an application to which the present invention is applied prepares the general-purpose conditions in advance and holds the general-purpose conditions in the condition resetting unit 6. The metadata used in the general-purpose conditions are classified in three metadata types shown in FIG. 5, and the resetting process is performed such that setting methods are changed depending on the types.

Type 1 of metadata has a character that uniquely determines permission/inhibition of watching depending on an age as in a parental guidance. Since such metadata must be dependent on the age of a user, the set value of the general-purpose conditions is an updated set value. For example, for a user whose age changes from fourteen to fifteen, a set value of the contents extraction conditions 4 before updating wherein watching is inhibited when the set value of the parental guidance is less than PG15 is updated into a set value of the general-purpose conditions and the contents extraction conditions 4 after updating wherein watching is inhibited when the set value of the parental guidance is less than PG16.

Type 2 of metadata has a character that suggests gradual degrees such as warning to delineation contents such as violence or sex. In general, with respect to the metadata, a permissible range to which contents belong is widened with an increase in age. However, it is preferable for a user who always hates a scene of violence that the permissible range is not merely widened. For this reason, in the metadata of type 2, of the settings of the general-purpose conditions, only settings suitable for the taste of a user are updated to widen the permissible range. Settings which are not matched with the taste of the user are not updated to prevent the permissible range from being widened. For example, with respect to a user who accepts abuseful language but hates a scene of violence, when an acceptance level of warning is raised in the general-purpose conditions with an increase in age, the settings of the general-purpose conditions are changed for warning related to linguistic usage, and the contents extraction conditions 4 for warning related to violence are not changed.

Type 3 of metadata has a character in that, although an appropriate set value is changed depending on ages as in an audience group supposed by a program such as an age group or an education level, observance is not forced. Audience groups to which the metadata belongs may change with an increase in age. More specifically, a user may not belong an audience group to which the user belongs before an increase in age after increase in age, or a user may belong an audience group to which the user does not belong before an increase in age after the increase in age. For example, a user whose age changes from twelve to thirteen does not belong to an audience group of primary school children and belongs to a new audience group of junior high school students. When audience groups to which a user belongs are changed with an increase in age, contents corresponding to the audience group to which the user belongs before the increase in age are not extracted in contents extraction performed in consideration of only the audience groups, and contents corresponding to the audience group to which the user belongs after the increase in age are extracted. However, for a primary school child who likes infant programs or a junior high school student who hates educational programs, it is preferable that contents corresponding to the audience group to which the user belongs before the increase in age are extracted or that contents corresponding to the audience group to which the user belongs after the increase in age are not extracted. For this reason, in metadata of type 3, an audience group to which the user belongs only before an increase in age is left after the updating when the audience group is matched with the taste of the user, so that contents strongly matched with the taste of the user are designed to be extracted even though the audience groups are changed with the increase in age. In addition, an audience group to which the user belongs after an increase in age is not updated when the audience group is not matched with the taste of the user, so that contents weakly matched with the taste of the user are designed not to be extracted even though the audience groups are changed with the increase in age.

In this manner, in the metadata of type 3, with respect to a set value (audience group to which a user does not belong after an increase in age) which is included in the contents extraction conditions 4 but is not included in the general-purpose conditions, only an audience group matched with the taste of the user is left. With respect to a set value (audience group to which the user belongs after the increase in age) which is included in the general-purpose conditions, but is not included in the contents extraction conditions 4, only an audience group which is not matched with the taste of the user is excluded. For example, for a user who graduated from a primary school and entered a junior high school, an audience group of primary school children is an audience group which is not included in the general-purpose conditions and to which the user does not belong after the increase in age. For this reason, when the user does not watch a program oriented to children and an educational program, the audience group is excluded from the settings of the contents extraction conditions 4 because the user has a weak taste. When the user frequently watches cartoon shows, the settings of the contents extraction conditions 4 are continued because the taste of the user is conditionally strong. In this example, since an audience group of junior high school students is an audience group which is included in only the general-purpose conditions and to which the user belongs after the increase in age, when a user who frequently watch educational programs has a strong taste for the audience group, the audience group is set in the contents extraction conditions 4. When a user who does not watch educational programs at all has a weak taste for the audience group, the audience group is not set in the contents extraction conditions 4. In this manner, different methods for resetting the contents extraction conditions 4 are used depending on types to which metadata to be handled belongs.

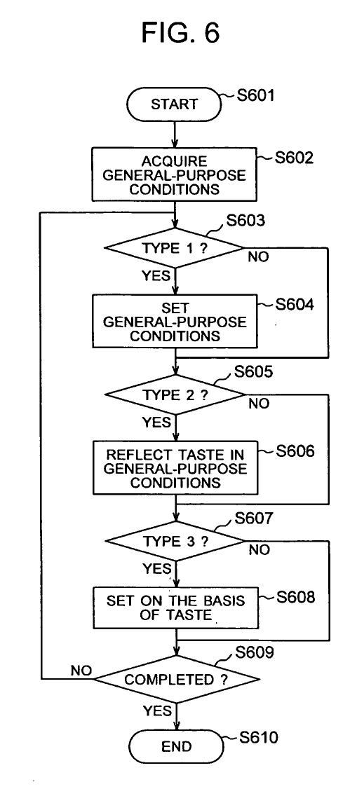

A processing flow of the condition resetting unit 6 is shown in FIG. 6.

A condition resetting process is started when the age of a user is updated by the age-increase process unit 5 (S601). When the condition resetting process is started, general-purpose conditions corresponding to the age of the user and the contents extraction conditions 4 are acquired (S602). When metadata included in the general-purpose conditions and/or the contents extraction conditions 4 is of type 1 (yes in S603), settings of the general-purpose conditions corresponding to the age are employed (S604). When the metadata included in the general-purpose conditions and/or the contents extraction conditions 4 is of type 2 (yes in S605), setting in consideration of the taste of the user is performed within the range of the settings of the general-purpose conditions corresponding to the age (S606). When the metadata included in the general-purpose conditions and/or the contents extraction conditions 4 is of type 3 (yes in S607), it is determined on the basis of the taste of the user whether the settings of the general-purpose conditions are employed (S608). All the metadata included in the general-purpose conditions and/or the contents extraction conditions 4 are completely tested (yes in S609), the condition resetting process is ended (S610).

The contents extraction unit 7 extracts contents having the metadata corresponding to the contents extraction conditions 4 updated as described above on the basis of the metadata held in the metadata holding unit 1 to acquire the corresponding contents. The contents extraction conditions 4 handled by the contents extraction unit 7 are generated by the user taste learning unit 3 and updated by learning performed everyday regardless of the increase in age of the user. The extraction of the contents performed by the contents extraction unit 7 is started at power-on time of the power supply of the apparatus to which the present invention is applied or appointed time (every hour, 0 minutes and 30 minutes, or the like), when a button for browsing a program guide displayed on a screen is depressed, when a key, which is arranged on a remote controller, for browsing a program guide is depressed, or the like.

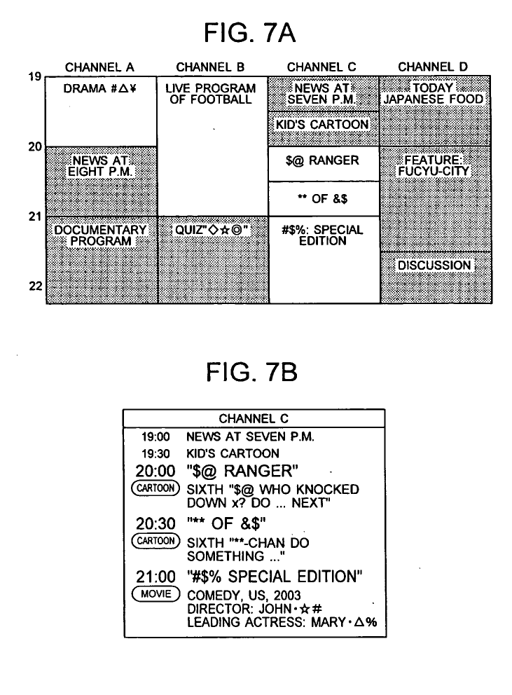

The contents extracted by the contents extraction unit 7 and metadata related to the contents can be displayed on a display unit such as a display as an electronic program guide or a recommended program guide. FIGS. 7A to 7B show displays of electronic program guides. FIG. 7A shows a program guide of channels A to D from 19 to 22 o'clock. Metadata related to the extracted contents is displayed by a bold-line frame, and metadata of unextracted contents is displayed by a hatched area, so that the metadata related to the extracted contents becomes better in visibility. Letters larger than those of the unextracted contents are used to display the program title metadata of the extracted contents, so that the visibility is improved. In addition to the above example, when background colors, a marking, and the like are devised, the visibility of the metadata related to the extracted contents is expected to be improved. FIG. 7B shows a program guide of channel C from 19 to 22 o'clock. The program start time metadata and the program title metadata of the extracted contents are displayed with letters larger than those of the unextracted contents, and a marking corresponding to category metadata and the contents of the program descriptive text metadata are displayed with respect to the extracted contents. In this manner, methods of displaying the extracted contents and the unextracted contents are made different from each other, so that the visibility of the metadata related to the extracted contents can be improved.

The metadata holding unit 1 is constituted by a storage device such as a RAM. The user taste learning unit 3, the age-increase process unit 5, the condition resetting unit 6, and the contents extraction unit 7 are constituted by a computer (CPU and MPU) which executes software for realizing processing of the contents extraction method and a storage device such as a RAM or a ROM for storing data. Such the contents extraction apparatus can be constituted as a video recording apparatus such as a tuner or a hard disk recorder and a display apparatus having a display. However, the contents extraction apparatus is not limited to these apparatuses.

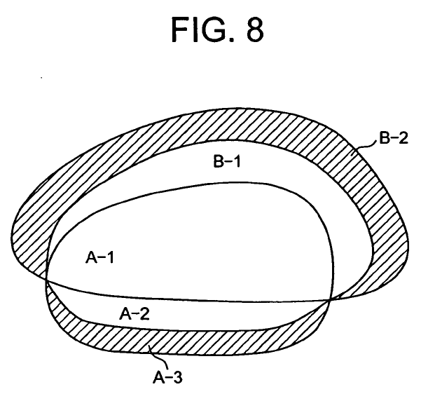

FIG. 8 is a conceptual diagram related to transition of extraction target contents. Regions A-1, A-2, and A-3 in FIG. 8 indicate contents to be extracted before updating, i.e., before an increase in age. Regions A-3, B-1, and B-2 indicate the contents corresponding to general-purpose conditions corresponding to the updated age of the user. Of the contents corresponding to the general-purpose condition, the contents belonging to the region B-1 are contents for which the user has a strong taste, so that the contents are included in contents to be extracted after the updating. Since the contents belonging to the region B-2 are contents for which a user does not have a strong taste, the contents are not included in the contents to be extracted after the updating. The regions A-2 and A-3 to which the contents to be extracted before updating do not correspond to the general-purpose conditions corresponding to the updated age of the user. However, since the contents belonging to the region A-2 are contents for which the user has a strong taste. For this reason, the contents are included in the contents to be extracted after the updating. The contents belonging to the region A-3 are contents for which the user does not have a strong taste, so that the contents are not included in the contents to be extracted after the updating. More specifically, the contents to be extracted after the updating in FIG. 8 are contents belonging to the regions A-1, A-2, and B-1. In this manner, transition of the contents to be extracted before and after the updating is performed such that the contents to be extracted before the updating are partially excluded and added with new contents.

According to the embodiment, contents extraction conditions in which the user taste information based on a history of watching and recording of programs is reflected are reset in an increase in age without causing a user to perform an operation, so that the contents extraction conditions can be automatically updated. For this reason, even though a user does not perform resetting once a year, the user can extracts the contents suitable for the taste and age of the user. In addition, since the number of contents extracted by updating is always optimized on the basis of the age and taste of the user, cumbersome operations such as operations that browses an electronic program guide and searches for programs can be prevented from being increased.

To store a software program code for realizing the processing described in the embodiment in a computer (CPU or MPU) to which the contents extraction method is applied and to execute the program code are included in the scope of the present invention. The program code and a storage medium (a floppy (registered trade name)) disk, a hard disk, an optical disk, a magnetooptical disk, a CD-ROM, a magnetic tape, a nonvolatile memory card, a ROM, or the like) storing the program code constitute the present invention.

### Second Embodiment

The first embodiment describes updating of contents extraction conditions in an age-increase process. However, contents extraction can also be performed such that contents are further narrowed down.

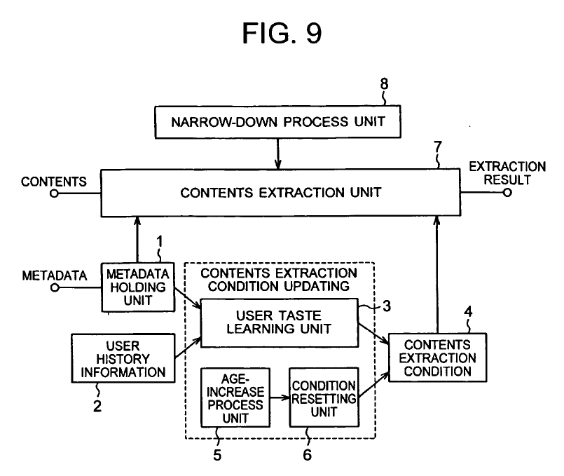

FIG. 9 is a functional block diagram of a contents extraction method to which the second embodiment of the present invention is applied.

A metadata holding unit 1 holds program related information (metadata) transmitted from a broadcast station or the like. A user taste learning unit 3 learns the taste of a user by using the metadata held in the metadata holding unit 1 and the user operation history information 2 to generate contents extraction conditions 4. The taste of the user is extracted by analyzing metadata of programs corresponding to operation history information of the user such as watching and recording history information. Since the contents extraction conditions 4 are based on the taste of the user, different users have different contents extraction conditions 4, respectively. On the other hand, an age-increase process unit 5 updates a set age of the user if necessary on the basis of current date information and the birth date information of the user. When the set age of the user is updated, a condition resetting unit 6 updates the contents extraction conditions 4. A contents extraction unit 7 specifies the contents having the metadata corresponding to the contents extraction conditions 4 in the metadata held in the metadata holding unit 1. A narrow-down processing unit 8 narrows down metadata related to the contents specified by the contents extraction unit 7. The contents extraction unit 7 specifies the contents having the narrowed-down metadata and acquires the corresponding contents from broadcast waves or the like. In this case, the narrow-down processing unit 8 is constituted by a computer (CPU or MPU) which executes software for realizing processing of the contents extraction method and/or a storage device such as a RAM or a ROM for storing data.

The operations of the age-increase process unit 5 and the condition resetting unit 6 are equal to the operations described in the first embodiment.

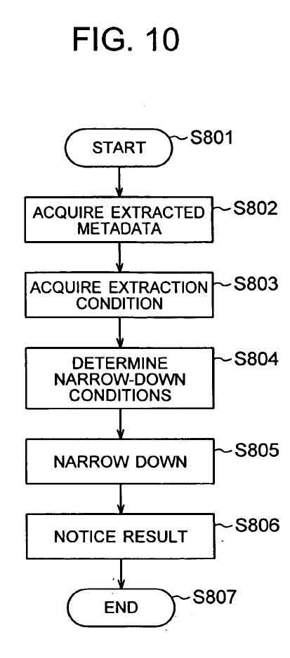

A narrow-down process flow chart in the narrow-down processing unit 8 is shown in FIG. 10. The narrow-down process is started at power-on time of the apparatus to which the present invention is applied, appointed time (every 3 a.m. or the like), or when a narrow-down process is designated by a user (S801). The designation of the narrow-down process by the user is to depress a narrow-down button or recommendation button displayed on a screen, to depress a narrow-down key or a recommendation key which is arranged on a remote controller, or the like. When the narrow-down process is started, of the metadata held in the metadata holding unit 1, metadata extracted by the contents extraction unit 7 is acquired (S802) to acquire the contents extraction conditions 4 (S803). Subsequently, narrow-down conditions are determined by using the acquired metadata and the contents extraction conditions 4 (S804). The narrow-down process is performed on the basis of the narrow-down conditions (S805), and results are displayed (S806). Even though the metadata and the contents extraction conditions 4 are referred to without being acquired, the narrow-down process can be performed. The narrow-down conditions are determined at a timing different from that of the narrow-down process, the narrow-down conditions can also be referred to in the narrow-down process.

As a method of determining narrow-down conditions, a method of determining several metadata specially important to a user, a method of determining a relation between metadata specially important to a user on the basis of a combination of set values between metadata, a method of using a ranking result of contents extracted under the contents extraction conditions 4, and the like may be used.

The metadata important to a user is metadata having a high degree of dependence on the taste of the user. For example, to a user who watches only programs of football games, a sub-category=football is important metadata. To a user who watches only programs of American cinemas, category=movie and country of production=United States are important metadata.

When a narrow-down process is performed by using the contents extraction conditions 4 in which the age and taste of a user are reflected and the metadata, a narrow-down method except for the methods described above may be used.

When important metadata are used as narrow-down conditions, contents having the important metadata are extracted to perform a narrow-down process. For example, even though a user who defines important metadata in which (1) sub-category=foreign movie, (2) delineation of violence=level of no blood is permitted, (3) keyword=hot spring, (4) sub-category=football, and (5) country of production=United States, are satisfied, has a history of watching an European movie or a musical program, the contents are narrowed down to American movies having less delineation of violence, programs that introduce hot springs, and the like.

When a relation between metadata obtained from a combination between set values of metadata is used as the narrow-down conditions, contents corresponding to metadata having the same set value as that of the determined combination are extracted to perform a narrow-down process. For example, for a user defines the most important metadata as metadata in which sub-category=football or live flag=true (live flag has a value of true when the program is a live program, and has a value of false when the program is not a live program) in category=sports in the important metadata or live=true is in related metadata such as keyword=final is the most important metadata, sports programs are narrowed down to live sports program. Similarly, the following narrow-down processes depending on the tastes of users can also be performed. That is, movies are narrowed down to action movies, and dramas are narrowed down to dramas in which XXX appears of drams.

When a ranking result of contents extracted as the narrow-down conditions is used, a narrow-down process is performed by selecting high-ranking programs. For example, when eighty programs of all three hundred programs on Jul. 30, 2003 correspond to the contents extraction conditions, the eighty programs are ranked on the first to eightieth places to make it possible to perform a narrow-down process. It is assumed that the ranking is performed in consideration of important metadata or a relation between metadata. Information about the importance and relativity of the metadata included in the contents extraction conditions 4 may be included in the contents extraction conditions 4 or held by the narrow-down processing unit 8.

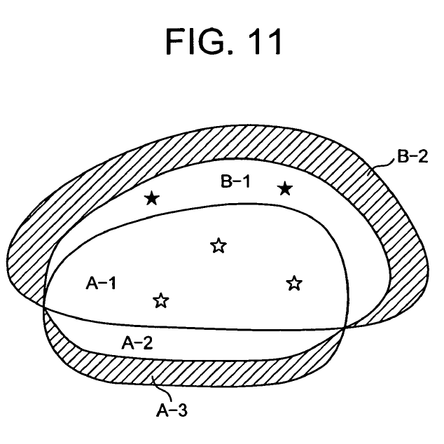

FIG. 11 is a conceptual diagram related to a narrow-down process from updated contents to be extracted. Transition of the contents to be extracted before and after the updating is the same as that in FIG. 8 in the first embodiment. Star signs in FIG. 11 indicate narrowed-down contents. With an increase/decrease of the contents to be extracted from the regions A-1 and A-2 before the updating to the regions A-1 and B-1 after the updating, the contents to be narrowed down become contents which can be narrowed down under the conditions before the updating (outline star signs in FIG. 11) and/or contents which are narrowed down for the first time under the conditions after the updating (black star signs in FIG. 11). The contents increase or decrease in number before and after the updating.

The narrowed-down contents are noticed to a user. As a notice method, a table or an electronic program guide constituted by only metadata related to the narrowed-down contents may be formed and displayed on a screen, and it may be expressed by a mark or the like that the contents are narrowed down in the electronic program guide before the narrow-down process. Since the narrowed-down contents are based on the taste of the user, the likelihood that the contents attract interest of the user is very high, and the contents can be regarded as recommended contents. Furthermore, the total number of narrowed-down contents is not huge, the visibility becomes high.

According to the embodiment, content extraction conditions in which user taste information is reflected are automatically updated in an increase in age of the user, and the contents extracted under the contents extraction conditions are narrowed down to notice a result to the user, so that a program matched with the taste of the user can be preferentially noticed to the user. In addition, since the contents extraction condition are updated in accordance with the age of the user, the contents can be narrowed down according to the growth of the user without forcibly causing the user to consciously perform resetting.

### Third Embodiment

In a third embodiment, a case in which a method of displaying a contents list in accordance with updating of the contents extraction conditions with an increase in age is updated will be described.

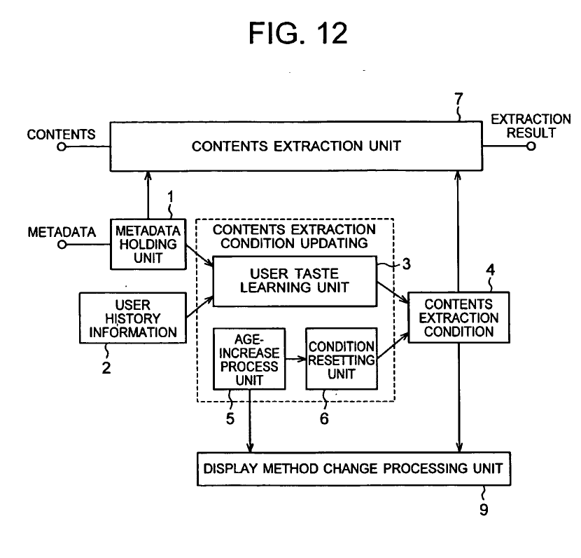

FIG. 12 is a functional block diagram of a contents extraction method to which the third embodiment of the present invention is applied.

A metadata holding unit 1 holds program related information (metadata) transmitted from a broadcast station or the like. A user taste learning unit 3 learns the taste of a user by using the metadata held in the metadata holding unit 1 and the user operation history information 2 to generate contents extraction conditions 4. The taste of the user is extracted by analyzing metadata of programs corresponding to operation history information of the user such as watching and recording history information. Since the contents extraction conditions 4 are based on the taste of the user, different users have different contents extraction conditions 4, respectively. On the other hand, an age-increase process unit 5 updates a set age of the user if necessary on the basis of current date information and the birth date information of the user. When the set age of the user is updated, a condition resetting unit 6 updates the contents extraction conditions 4. A contents extraction unit 7 specifies the contents having the metadata corresponding to the contents extraction conditions 4 in the metadata held in the metadata holding unit 1 to acquire the corresponding contents from broadcast waves or the like. A display method change processing unit 9 changes a design or the like used when the metadata extracted by the contents extraction unit 7 is displayed in accordance with updating of the age of the user by the age-increase process unit 5. In this case, the display method change processing unit 9 is constituted by a computer (CPU or MPU) which executes software for realizing processing of the contents extraction method and a storage device such as a RAM or a ROM for storing data.

The operations of the age-increase process unit 5 and the condition resetting unit 6 are equal to the operations described in the first embodiment.

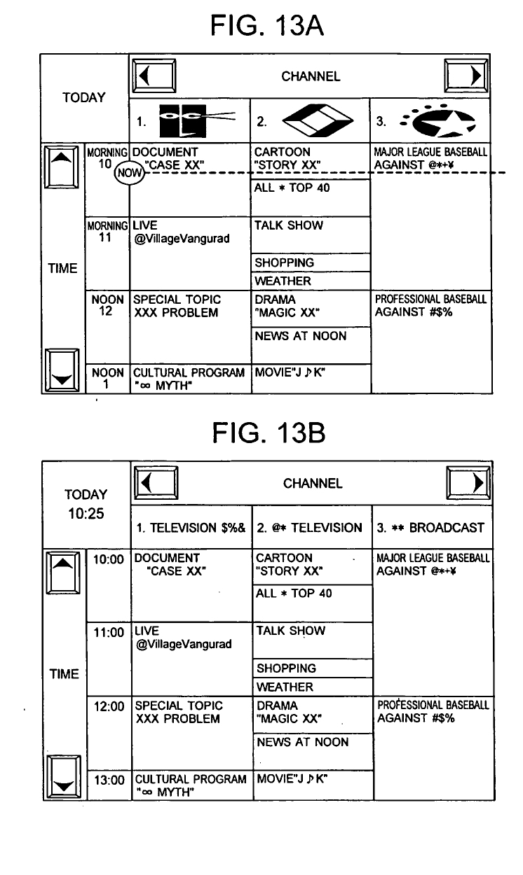

The display method change processing unit 9 holds display basic conditions corresponding to an age, and changes a method of displaying contents extracted on the basis of the display basic conditions. The display basic conditions corresponding to an age include the type and size of a font for display, a phrase to be used (view, watch, and the like), an expression method (hiragana, kanji with kana, kanji, and the like), and the like. When the display change process is performed, for example, a phrase written on a button for watching contents which are being selected in an electronic program guide can be changed into “view (with kana)” when the user is a preschooler, “view (with kana or kanji)” when the user is a primary school child, “view (with kanji)” when the user is a junior high school student, and “watch” when the user is a high school student or older. FIGS. 13A and 13B show displays corresponding to ages on an electronic program guide. FIG. 13A shows a case in which a user is a preschooler or a schoolchild in a lower grade, and FIG. 13B shows a case in which a user is an adult, so that expression methods of a channel axis and a time axis on the electronic program guide are made different from each other.

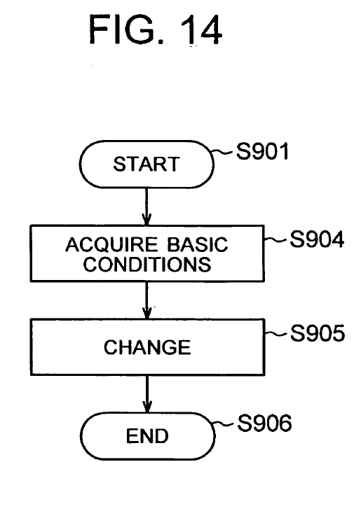

FIG. 14 is a process flow chart of the display method change processing unit 9. A display change process is started when the age of a user is updated in the age-increase process unit 5 (S901). When the display change process is started, display basic conditions corresponding to the age of the user are acquired (S904), and the display method is changed into the display method expressed by the display basic conditions (S905).

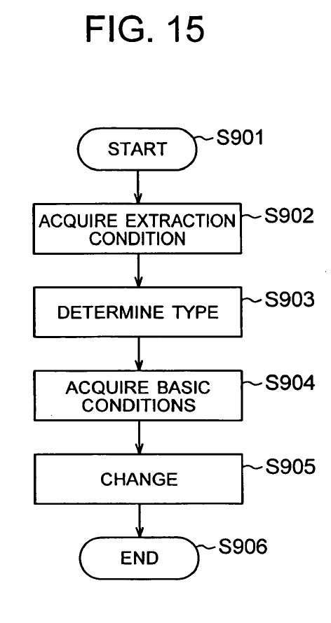

In the display method in FIG. 14, although the age of the user is considered, the taste of the user is not considered. FIG. 15 is a process flow chart of the display method change processing unit 9 when the taste of the user is considered together with the age of the user.

When the display change process is started (S901), the contents extraction conditions 4 serving as user taste information are acquired (S902), and a user type is determined (S903). Display basic conditions corresponding to the determined user type are acquired (S904), and the display method is changed into the display method expressed by the display basic conditions (S905). A plurality of user types are known and managed by the display method change processing unit 9. An arbitrary user type is prepared.

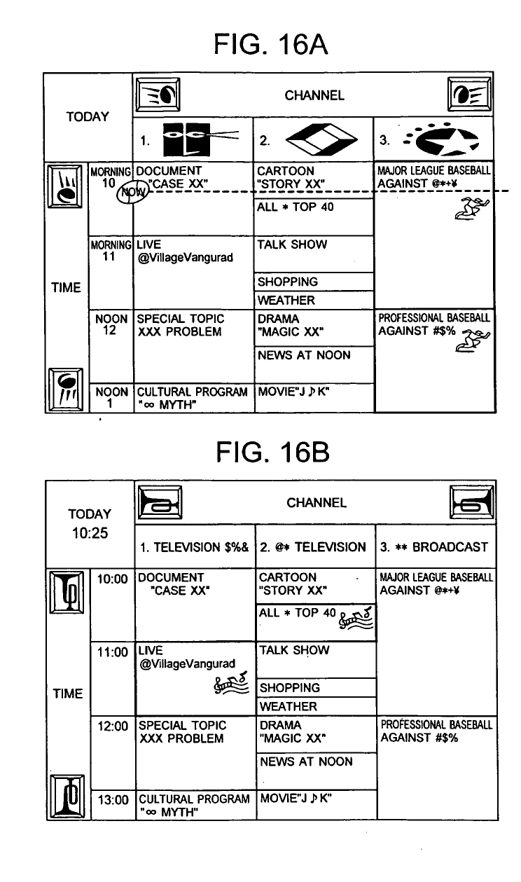

When user types are prepared for program types such as a sports program and a musical program, respectively, a user type based on a program type for which a user has the strongest taste is selected. Displays of electronic program guides in the above case are shown in FIGS. 16A and 16B. FIG. 16A shows the display for a user who is a child and likes baseball. In FIG. 16A, the shapes of balls and players are used as the shapes of buttons and marks in the screen. FIG. 16B shows the display for a user who is an adult and likes musical programs. In FIG. 16B, the shapes of musical notations and musical instruments are used as the shapes of buttons and marks in the screen. In addition, as the shapes of buttons and marks in the screen, the shapes of swords and precious stones are used for a user who likes adventure movies, and the shapes of castles and flags are used for a user who likes period dramas to consider the taste of users. In addition to the shapes of buttons and marks in the screen, for backgrounds, fonts, sound effect, and the like, consideration based on a program type can also be performed.

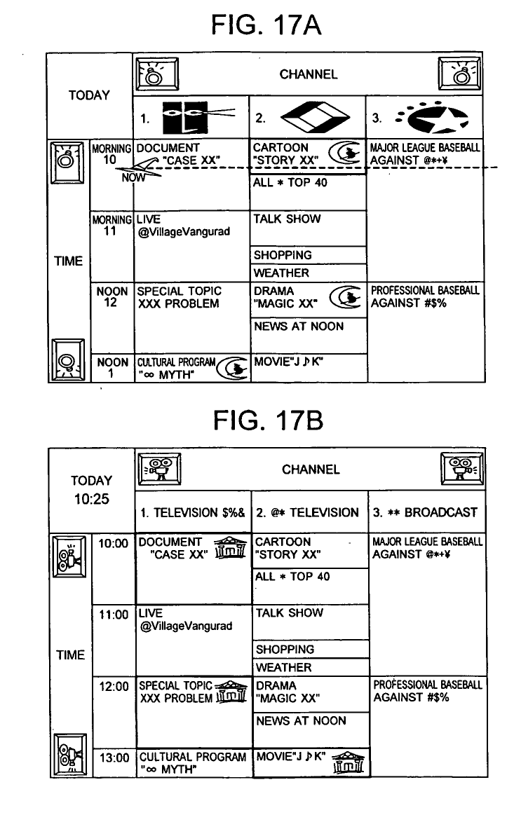

When not a program type, but a user type corresponding to an interest field of a user such as political economics or fantasy is prepared, the closest user type is selected. Displays of electronic program guides in the above case are shown in FIGS. 17a and 17B. FIG. 17A shows a display for a user type of a user who is a child and is interested in a field related to imaginary things. As the shapes of buttons and marks in a screen, the shapes of witches and magic words are used. FIG. 17B shows a display for a user type of a user who is an adult and is interested in a field related to social problems such as a documentary program of an actual case. As the shapes of buttons and marks in a screen, the shapes of famous buildings and broadcast equipment are used. In addition, as the shapes of buttons and marks in a screen, the shapes of knives and the side faces of famous detectives are used in a user type of a user who is interested in a field related to mysteries or horror, and hot spring marks and the shapes of coins are used in a user type of a user who is interested in a field related to acquisition of information about travels, shopping, and the like, so that the tastes of the users are considered. In addition to the shapes of buttons and marks in a screen, consideration based on a user type can also be performed to backgrounds, fonts, sound effect, and the like.

When an interest field of a user is handled as a user type, a user who eminently likes programs of specific type, i.e., who frequently watches horror movies is associated with a specific user type, and a user who has an eminent taste for a specific keyword related to different program types, i.e., who frequently watches movies, documentary programs handling cases and accidents or news or reportage programs can also be associated with a specific user type. After the user type is determined in this manner, consideration (fonts, phrases, and the like) corresponding to the age of a user is performed. The display basic conditions managed by the display method change processing unit 9 may be held in advance in the apparatus to which the present invention is applied, or may be downloaded when the apparatus can acquire external information from a network or the like.

When the contents extraction conditions 4 and the display method are changed in accordance with updating of the age of a user, an electronic program guide or the like is changed and displayed.

According to the embodiment, contents extraction conditions in which user taste information is reflected are automatically updated in an increase in age of a user, and a display method corresponding to the updated age of the user is selected, so that not only preferential extraction of a program matched with the taste of the user, but also provision of extracted contents to the user by using a display method corresponding to the age of the user can be achieved.

In the present invention, a user serving as a base of taste information and a user the set age of which is updated need not be perfectly equal to each other. For example, the user the set age of which is updated may be a child in a certain home, and the taste information may be taste information set by parents in the home. In this manner, programs which are inhibited by the parents from being watched by the child can be properly managed with updating of a set age, and programs watched by the child can be properly managed by the parent. In this case, in place of the user operation history information 2, i.e., in place of storage of an operation history, taste information is stored in a storage device by an input operation of a user in advance, and the stored information is used as taste information.

In the present invention, as a reference date (age-increase date) on which a set age of a user is updated, as described above, the birth date of the user, the start date of a year, i.e., January first, or the start date of a school year, i.e., April first or September first may be used.

This application claims priority from Japanese Patent Application No.2003-392151 filed Nov. 21, 2003, which is hereby incorporated by reference herein.

1. A contents extraction method comprising the step of:
updating a set age of a user on the basis of information related to reference time at which the set age of the user is updated and time information which is updated with time;
resetting extraction conditions of contents such that at least one of the contents extracted before the updating is excluded in accordance with taste information of the user and the updated set age; and
extracting contents which can be an object to be watched by the user from a plurality of contents depending on the extraction conditions.

2. A contents extraction method comprising the step of:
updating a set age of a user on the basis of information related to reference time at which the set age of the user is updated and time information which is updated with time;
resetting extraction conditions of contents in accordance with taste information of the user and the updated set age; and
extracting contents which can be an object to be watched by the user from a plurality of contents depending on the extraction conditions.

3. The contents extraction method according to claim 2, wherein under the extraction conditions, at least one of the contents extracted before the updating is excluded and/or at least one of contents which are not an object to be extracted before the updating is added to extract contents.

4. The contents extraction method according to claim 3, wherein under the extraction conditions, candidates of contents to be excluded are selected in accordance with the updated set age, and contents to be excluded are determined in the candidates in accordance with the taste information of the user.

5. The contents extraction method according to claim 3, wherein, of candidates of the contents to be excluded, contents which are not matched with the taste of the user are excluded.

6. The contents extraction method according to claim 2, comprising the step of further restricting contents to be extracted from the plurality of extracted contents on the basis of contents related information associated with the contents.

7. A contents information display method wherein a display state of information related to contents extracted depending on the contents extraction method according to claim 2 can be updated in accordance with updating of a set age.

8. A contents information display method wherein, in a state in which the visibility of information related to contents extracted by the contents extraction method according to claim 2 is higher than the visibility of information related to unextracted contents, information related to these contents is displayed.

9. A contents extraction apparatus comprising:
an age-increase process unit which updates a set age of a user on the basis of information related to reference time at which the set age of the user is updated and time information which is updated with time;
a contents related information holding unit which holds contents related information associated with the contents;
a user taste information learning unit which learns taste information of the user on the basis of operation history information of the user and contents related information corresponding to the operation;
a condition resetting unit which resets extraction conditions of contents such that at least one of the contents extracted before the updating is excluded in accordance with taste information of the user and the updated set age; and
a contents extraction unit which extracts contents which can be an object to be watched by the user from a plurality of contents depending on the reset extraction conditions.

10. A contents extraction apparatus comprising:
an age-increase process unit which updates a set age of a user on the basis of information related to reference time at which the set age of the user is updated and time information which is updated with time;
a contents related information holding unit which holds contents related information associated with the contents;
a user taste information learning unit which learns taste information of the user on the basis of operation history information of the user and contents related information corresponding to the operation;
a condition resetting unit which resets extraction conditions of contents in accordance with taste information of the user and the updated set age; and
a contents extraction unit which extracts contents which can be an object to be watched by the user from a plurality of contents depending on the reset extraction conditions.

11. The contents extraction apparatus according to claim 10, wherein under the extraction conditions, at least one of the contents extracted before the updating is excluded and/or at least one of contents which are not an object to be extracted before the updating is added to extract contents.

12. The contents extraction apparatus according to claim 11, wherein under the extraction conditions, candidates of contents to be excluded are selected in accordance with the updated set age, and contents to be excluded are determined in the candidates in accordance with the taste information of the user.

13. The contents extraction apparatus according to claim 11, wherein, of candidates of the contents to be excluded, contents which are not matched with the taste of the user are excluded.

14. The contents extraction apparatus according to claim 10, further comprising a narrow-down process unit which further restricts contents to be extracted from the plurality of extracted contents on the basis of contents related information associated with the contents.

15. A display apparatus comprising:
the contents extraction apparatus according to claim 10;
a display unit which displays information related to the contents; and
a display method change unit which updates a display state of information related to the extracted contents depending on updating of a set age.

16. A display apparatus comprising:
the contents extraction apparatus according to claim 10;
a display unit which displays information related to the contents; and
a display method change unit which changes a display method of information related to the contents such that the visibility of information related to extracted contents is higher than the visibility of information related to unextracted contents.
